(19) United States
(12) Patent Application Publication
(10) Pub. No.: US 2021/0102004 A1
(43) Pub. Date: Apr. 8, 2021

(54) EFFICIENT PROCESS OF PREPARING AN ESTERIFIED CELLULOSE ETHER

(71) Applicant: Dow Global Technologies LLC, Midland, MI (US)

(72) Inventors: Meinolf Brackhagen, Walsrode (DE); Oliver Petermann, Hamburg (DE); Rene Kelling, Bomlitz (DE)

(21) Appl. No.: 16/072,744

(22) PCT Filed: Oct. 17, 2017
(86) PCT No.: PCT/US2017/056836

§ 371 Date: Jul. 25, 2018

Related U.S. Application Data
(60) Provisional application No. 62/409,408, filed on Oct. 18, 2016.

(51) Int. Cl. C08B 13/00

(52) U.S. Cl. CPC C08B 13/00

(57) ABSTRACT

An esterified cellulose ether is produced in a highly efficient manner in a process for reacting a cellulose ether with an aliphatic monocarboxylic acid anhydride and a dicarboxylic acid anhydride, wherein the process comprises the steps of a) preparing a reaction mixture comprising the cellulose ether, the aliphatic monocarboxylic acid anhydride and the aliphatic carboxylic acid such that the molar ratio of aliphatic carboxylic acid to anhydroglucose units of cellulose ether is up to 9.0:1 and heating the reaction mixture to a temperature of from 60° C. to 110° C. prior to, during or after mixing the components of the reaction mixture, and b) keeping the reaction mixture at least 15 minutes at the temperature of from 60° C. to 110° C. before adding dicarboxylic acid anhydride to the reaction mixture.

### FIELD

The present invention relates to an efficient process for preparing an esterified cellulose ether.

### INTRODUCTION

Esters of cellulose ethers, their uses and processes for preparing them are generally known in the art. Known methods of producing cellulose ether-esters include the reaction of a cellulose ether with an aliphatic monocarboxylic acid anhydride or a dicarboxylic acid anhydride or a combination thereof, for example as described in U.S. Pat. Nos. 4,226,981 and 4,365,060.

Various known esters of cellulose ethers are useful as enteric polymers for pharmaceutical dosage forms, such as methylcellulose phthalate, hydroxypropyl methylcellulose phthalate, methylcellulose succinate, or hydroxypropyl methylcellulose acetate succinate (HPMCAS). Enteric polymers are those that are resistant to dissolution in the acidic environment of the stomach. Dosage forms coated with such polymers protect the drug from inactivation or degradation in the acidic environment or prevent irritation of the stomach by the drug. U.S. Pat. No. 4,365,060 discloses enterosoluble capsules which are said to have excellent enterosolubility behavior.

International Patent Applications WO 2014/031447 and WO 2014/031448 disclose methods of controlling the molecular weight of esterified cellulose ethers like HPMCAS. WO2014/031447 discloses that the molecular weight of HPMCAS increases with decreasing molar ratio [aliphatic carboxylic acid/anhydroglucose units of cellulose ether]. WO2014/031448 discloses that the molecular weight of HPMCAS increases with increasing molar ratio [alkali metal carboxylate/anhydroglucose units of cellulose ether]. The aliphatic carboxylic acid and the alkali metal carboxylate are used as reaction diluent and reaction catalyst, respectively.

In view of the great importance of esterified cellulose ethers, such as HPMCAS, for the pharmaceutical industry and the corresponding high demand of these esterified cellulose ethers, it is desired to improve the raw material utilization in the process for producing esterified cellulose ethers, e.g., by decreasing the molar ratio between aliphatic carboxylic acid and cellulose ether. Decreasing the molar ratio [aliphatic carboxylic acid/anhydroglucose units of cellulose ether] in the production of esterified cellulose ethers increases the molecular weight of the esterified cellulose ethers, as disclosed in the International patent application Nos. WO2014/031447 and WO 2014/031419.

International Patent Application WO 2014/031419 discloses the production of an esterified cellulose ether having a weight average molecular weight of 80,000-350,000 Dalton. The molar ratio [aliphatic carboxylic acid/anhydroglucose units of cellulose ether] utilized in the reaction is from [4.9/1.0] to [11.5/1.0], preferably from [5.0/1.0] to [10.0/1.0], and more preferably from [5.5/1.0] to [9.0/1.0]. The molar ratio of [alkali metal carboxylate/anhydroglucose units of cellulose ether] utilized in the reaction is from [0.4/1.0] to [3.8/1.0], and preferably from [1.5/1.0] to [3.5/1.0].

International Patent Application WO 2014/031446 discloses the production of an esterified cellulose ether wherein the molar ratio [alkali metal carboxylate/anhydroglucose units of cellulose ether] is not more than [1.20/1] and the molar ratio [aliphatic carboxylic acid/anhydroglucose units of cellulose ether] is from [3.55/1] to [9.0/1]. Esterified cellulose ethers having weight average molecular weights of 166,000 to 299,000 Dalton are achieved according to the examples.

While in some end-uses a high weight average molecular weight of esterified cellulose ethers is desirable, esterified cellulose ethers of high weight average molecular weight usually exhibit a high viscosity when they are dissolved at a high concentration in an organic solvent, e.g. at a concentration of 7-10 wt. %. This reduces their efficiency in coating and spray-drying processes. High concentrations of the esterified cellulose ether in an organic solvent are desired to minimize the amount of solvent that has to be subsequently removed. On the other hand, the viscosity of the solution should be low to facilitate coating, spraying and spray-drying procedures. The correlation between the weight average molecular weight of esterified cellulose ethers and their viscosity in acetone, measured as a 10 wt. % solution at 20° C. is illustrated by Comparative Examples B-G of International Patent Application WO 2014/137789.

The weight average molecular weight and the viscosity of esterified cellulose ethers in acetone can be influenced by the viscosity of the cellulose ether used as a starting material for esterification. Comparative Examples A and B of WO 2014/137789 illustrate that HPMCAS of higher weight average molecular weight and much higher viscosity in acetone is produced when hydroxypropyl methyl cellulose (HPMC) having a viscosity of 6.0 mPa·s is used as a starting material than when HPMC having a viscosity of 3.1 mPa·s is used as a starting material, each HPMC measured as a 2.0 wt. % solution in water at 20° C. WO 2014/137789 discloses that esterified cellulose ethers, such as HPMCAS, of surprisingly low viscosity can be produced when the cellulose ether used as a starting material for esterification, such as HPMC, has a viscosity of from 1.20 to 2.33 mPa·s, measured as a 2 wt.-% solution in water at 20° C. Cellulose ethers of low viscosity can be obtained by subjecting a cellulose ether of higher viscosity to a partial depolymerization process, e.g., in the presence of and acid and/or an oxidizing agent. Unfortunately, very harsh conditions have to applied to obtain a cellulose ether of less than 3 mPa·s, which impacts the color of the partially depolymerized cellulose ether and accordingly the color of the esterified cellulose ether produced therefrom.

Hence, there is still the urgent need to find a way of decreasing the molar ratio of aliphatic carboxylic acid to cellulose ether utilized in the production of esterified cellulose ethers without unduly increasing the weight average molecular weight of the produced esterified cellulose ether and its viscosity in acetone.

Surprisingly, it has been found that an esterified cellulose ether can be produced at a low molar ratio of aliphatic carboxylic acid to cellulose ether while still producing an esterified cellulose ether of reasonably low weight average molecular weight and of reasonably low viscosity in acetone when the reactants are added to the reaction mixture at certain stages of the reaction.

### SUMMARY

One aspect of the present invention is a process for reacting a cellulose ether with an aliphatic monocarboxylic acid anhydride and a dicarboxylic acid anhydride in the presence of an aliphatic carboxylic acid, wherein the process comprises the steps of a) preparing a reaction mixture comprising the cellulose ether, the aliphatic monocarboxylic acid anhydride and the aliphatic carboxylic acid such that the molar ratio of aliphatic carboxylic acid to anhydroglucose units of cellulose ether is up to 9.0:1 and heating the reaction mixture to a temperature of from 60° C. to 110° C. prior to, during or after mixing the components of the reaction mixture, and b) keeping the reaction mixture at least 15 minutes at the temperature of from 60° C. to 110° C. before adding dicarboxylic acid anhydride to the reaction mixture.

Another aspect of the present invention is a process for producing an esterified cellulose ether of reduced weight average molecular weight or reduced viscosity in acetone or both in a process for reacting a cellulose ether with an aliphatic monocarboxylic acid anhydride and a dicarboxylic acid anhydride in the presence of an aliphatic carboxylic acid at a molar ratio of aliphatic carboxylic acid to anhydroglucose units of cellulose ether of up to 9.0:1, wherein the process comprises the steps of a) preparing a reaction mixture comprising the cellulose ether, the aliphatic monocarboxylic acid anhydride and the aliphatic carboxylic acid such that the molar ratio of aliphatic carboxylic acid to anhydroglucose units of cellulose ether is up to 9.0:1 and heating the reaction mixture to a temperature of from 60° C. to 110° C. prior to, during or after mixing the components of the reaction mixture, and b) keeping the reaction mixture at least 15 minutes at the temperature of from 60° C. to 110° C. before adding dicarboxylic acid anhydride to the reaction mixture.

### DESCRIPTION OF EMBODIMENTS

The cellulose ether used as a starting material in the process of the present invention has a cellulose backbone having (3-1,4 glycosidically bound D-glucopyranose repeating units, designated as anhydroglucose units in the context of this invention. The cellulose ether preferably is an alkyl cellulose, hydroxyalkyl cellulose or hydroxyalkyl alkylcellulose. This means that in the cellulose ether utilized in the process of the present invention, at least a part of the hydroxyl groups of the anhydroglucose units are substituted by alkoxyl groups or hydroxyalkoxyl groups or a combination of alkoxyl and hydroxyalkoxyl groups. The hydroxyalkoxyl groups are typically hydroxymethoxyl, hydroxyethoxyl and/or hydroxypropoxyl groups. Hydroxyethoxyl and/or hydroxypropoxyl groups are preferred. Typically one or two kinds of hydroxyalkoxyl groups are present in the cellulose ether. Preferably a single kind of hydroxyalkoxyl group, more preferably hydroxypropoxyl, is present. The alkoxyl groups are typically methoxyl, ethoxyl and/or propoxyl groups. Methoxyl groups are preferred.

Illustrative of the above-defined cellulose ethers are alkylcelluloses, such as methylcellulose, ethylcellulose, and propylcellulose; hydroxyalkylcelluloses, such as hydroxyethylcellulose, hydroxypropylcellulose, and hydroxybutylcellulose; and hydroxyalkyl alkylcelluloses, such as hydroxyethyl methylcellulose, hydroxymethyl ethylcellulose, ethyl hydroxyethylcellulose, hydroxypropyl methylcellulose, hydroxypropyl ethylcellulose, hydroxybutyl methylcellulose, and hydroxybutyl ethylcellulose; and those having two or more hydroxyalkyl groups, such as hydroxyethylhydroxypropyl methylcellulose. Most preferably, the cellulose ether is a hydroxyalkyl methylcellulose, such as hydroxypropyl methylcellulose.

The degree of the substitution of hydroxyl groups of the anhydroglucose units by hydroxyalkoxyl groups is expressed by the molar substitution of hydroxyalkoxyl groups, the MS(hydroxyalkoxyl). The MS(hydroxyalkoxyl) is the average number of moles of hydroxyalkoxyl groups per anhydroglucose unit in the cellulose ether. It is to be understood that during the hydroxyalkylation reaction the hydroxyl group of a hydroxyalkoxyl group bound to the cellulose backbone can be further etherified by an alkylation agent, e.g. a methylation agent, and/or a hydroxyalkylation agent. Multiple subsequent hydroxyalkylation etherification reactions with respect to the same carbon atom position of an anhydroglucose unit yields a side chain, wherein multiple hydroxyalkoxyl groups are covalently bound to each other by ether bonds, each side chain as a whole forming a hydroxyalkoxyl substituent to the cellulose backbone.

The term “hydroxyalkoxyl groups” thus has to be interpreted in the context of the MS(hydroxyalkoxyl) as referring to the hydroxyalkoxyl groups as the constituting units of hydroxyalkoxyl substituents, which either comprise a single hydroxyalkoxyl group or a side chain as outlined above, wherein two or more hydroxyalkoxy units are covalently bound to each other by ether bonding. Within this definition it is not important whether the terminal hydroxyl group of a hydroxyalkoxyl substituent is further alkylated, e.g. methylated, or not; both alkylated and non-alkylated hydroxyalkoxyl substituents are included for the determination of MS(hydroxyalkoxyl). The cellulose ether utilized in the process of the invention generally has a molar substitution of hydroxyalkoxyl groups in the range 0.05 to 1.00, preferably 0.08 to 0.90, more preferably 0.12 to 0.70, most preferably 0.15 to 0.60, and particularly 0.20 to 0.40.

The average number of hydroxyl groups substituted by alkoxyl groups, such as methoxyl groups, per anhydroglucose unit, is designated as the degree of substitution of alkoxyl groups, DS(alkoxyl). In the above-given definition of DS, the term “hydroxyl groups substituted by alkoxyl groups” is to be construed within the present invention to include not only alkylated hydroxyl groups directly bound to the carbon atoms of the cellulose backbone, but also alkylated hydroxyl groups of hydroxyalkoxyl substituents bound to the cellulose backbone. The cellulose ethers utilized in the process of the invention generally have a DS(alkoxyl) in the range of 1.0 to 2.5, preferably from 1.1 to 2.4 , more preferably from 1.2 to 2.2 most preferably from 1.6 to 2.05, and particularly from 1.7 to 2.05.

The degree of substitution of alkoxyl groups and the molar substitution of hydroxyalkoxyl groups can be determined by Zeisel cleavage of the cellulose ether with hydrogen iodide and subsequent quantitative gas chromatographic analysis (G. Bartelmus and R. Ketterer, Z. Anal. Chem., 286 (1977) 161-190). Most preferably the cellulose ether utilized in the process of the invention is hydroxypropyl methylcellulose having a DS(methoxyl) within the ranges indicated above for DS(alkoxyl) and an MS(hydroxypropoxyl) within the ranges indicated above for MS(hydroxyalkoxyl).

The cellulose ether used as a starting material in the process of the present invention generally has a viscosity of up to 20 mPa·s, preferably up to 15 mPa·s, more preferably up to 10 mPa·s, and most preferably up to 7 mPa·s or up to 3.6 mPa·s, measured as a 2 weight-% aqueous solution at 20° C. according to ASTM D2363-79 (Reapproved 2006). Generally their viscosity is at least 1.8 mPa·s, typically at least 2.1 mPa·s, even more typically at least 2.4 mPa·s, and most typically at least 2.8 mPa·s, measured as a 2 weight-% aqueous solution at 20° C. Cellulose ethers of such viscosity can be obtained by subjecting a cellulose ether of higher viscosity to a partial depolymerization process. Partial depolymerization processes are well known in the art and described, for example, in European Patent Applications EP 1 141 029; EP 0 210 917; EP 1 423 433; and U.S. Pat. No. 4,316,982. Alternatively, partial depolymerization can be achieved during the production of the cellulose ethers, for example by the presence of oxygen or an oxidizing agent.

The molar number of anhydroglucose units of the cellulose ether utilized in the process of the present invention can be determined from the weight of the cellulose ether used as a starting material, by calculating the average molecular weight of the substituted anhydroglucose units from the DS(alkoxyl) and MS(hydroxyalkoxyl).

In step a) of the process of the present invention a reaction mixture is prepared which comprises the cellulose ether, an aliphatic monocarboxylic acid anhydride and an aliphatic carboxylic acid such that the molar ratio of aliphatic carboxylic acid to anhydroglucose units (AGUs) of cellulose ether is up to 9.0:1. Preferably the molar ratio of aliphatic carboxylic acid to AGUs of cellulose ether is up to 8.7:1, more preferably up to 8.0:1, and most preferably only up to 7.0:1 or even only up to 6.4:1. Generally the molar ratio of aliphatic carboxylic acid to AGUs of cellulose ether is at least 3.4:1, preferably at least 4.0:1, more preferably at least 4.5:1, and most preferably least 5.0:1.

A preferred aliphatic carboxylic acid used as a reaction diluent is acetic acid, propionic acid, or butyric acid. Minor amounts of other solvents or diluents which are liquid at room temperature and do not react with the cellulose ether, such as aromatic or aliphatic solvents like benzene, toluene, 1,4-dioxane, or tetrahydrofurane; or halogenated C₁-C₃ derivatives, like dichloro methane or dichloro methyl ether, can also be present as reaction diluent, but the amount of the aliphatic carboxylic acid should generally be more at least 75 percent, preferably at least 90 percent, and more preferably at least 95 percent, based on the total weight of the reaction diluent. Most preferably the reaction diluent consists of an aliphatic carboxylic acid.

Preferred aliphatic monocarboxylic acid anhydrides are selected from the group consisting of acetic anhydride, butyric anhydride and propionic anhydride. The molar ratio of the anhydride of the aliphatic monocarboxylic acid to the AGUs of the cellulose ether generally is 0.1:1 or more, preferably 0.3:1 or more, more preferably 0.5:1 or more, and most preferably 1.0:1 or more. The molar ratio of the aliphatic monocarboxylic acid anhydride to the AGUs of the cellulose ether generally is 5.0:1 or less, preferably 4.0:1 or less, more preferably 3.0:1 or less, and particularly 2.5:1 or less.

An esterification catalyst, preferably an alkali metal carboxylate, such as sodium acetate or potassium acetate, is typically also incorporated into the reaction mixture. A portion or the entire amount of the esterification catalyst utilized in the process of the present invention can be added in step a) to the reaction mixture. In one aspect of the invention the entire amount of the esterification catalyst utilized in the reaction is dissolved or dispersed in the aliphatic carboxylic acid. In another aspect of the invention only a portion of the esterification catalyst utilized in the reaction is incorporated into the reaction mixture in step a). In this aspect of the invention, generally 15 to 35 percent, preferably 20 to 30 percent of the total added amount of the esterification catalyst utilized in the reaction is incorporated into the reaction mixture in step a). The total amount of esterification catalyst utilized in the reaction preferably is that the molar ratio of esterification catalyst to the AGUs of the cellulose ether is 1.0:1 or more, more preferably 1.5:1 or more, and most preferably 1.9:1 or more. The total amount of esterification catalyst utilized in the reaction preferably is that the molar ratio of esterification catalyst to the AGUs of cellulose ether is 3.5:1 or less, more preferably 3.0:1 or less, and most preferably 2.5:1 or less. Preferably the preferred, more preferred and most preferred ranges for the molar ratio of esterification catalyst to the AGUs of the cellulose ether are combined with the preferred, more preferred and most preferred ranges for the molar ratio of aliphatic carboxylic to the AGUs of cellulose ether.

The reaction mixture in step a) of the process of the present invention is heated to a temperature of from 60° C. to 110° C. prior to, during or after mixing the components of the reaction mixture. Preferably the reaction mixture in step a) of the process is heated to a temperature of at least 70° C., and more preferably at least 75° C. or even at least 80° C. Preferably the reaction mixture in step a) of the process is heated to a temperature of up to 100° C., and more preferably of up to 95° C. or up to 90° C. In a preferred embodiment of the process, the cellulose ether, the aliphatic carboxylic acid and generally a portion or the entire amount of the esterification catalyst are first heated to a temperature in the above-mentioned range followed by addition of the anhydride of an aliphatic monocarboxylic acid.

In step b) of the process the reaction mixture comprising the cellulose ether, the aliphatic monocarboxylic acid anhydride, the aliphatic carboxylic acid and typically the esterification catalyst is kept at least 15 minutes, preferably at least 20 minutes, more preferably at least 25 minutes, and generally up to 60 minutes, preferably up to 45 minutes, and more preferably up to 35 minutes at a temperature in the above-mentioned ranges before any amount of dicarboxylic acid anhydride is added to the reaction mixture. Then a dicarboxylic acid anhydride is added to the reaction mixture. A preferred dicarboxylic acid anhydride is succinic anhydride, maleic anhydride or phthalic anhydride. Succinic anhydride or phthalic anhydride is more preferred. Succinic anhydride is the most preferred dicarboxylic acid anhydride. The molar ratio of the anhydride of a dicarboxylic acid to the AGUs of the cellulose ether generally is at least 0.01:1, preferably at least 0.04:1 and more preferably at least 0.2:1. The molar ratio of the anhydride of a dicarboxylic acid to the AGUs of cellulose ether generally is up to 2.0:1, preferably up to 1.0:1, and more preferably up to 0.5:1. If in step a) of the process only a portion of the esterification catalyst has been added, the remaining amount of esterification catalyst is added to the reaction mixture and the esterification reaction is allowed to further proceed. E.g., 65 to 85 percent, such as 70 to 80 percent, of the total amount of esterification catalyst can be added in step b). The reaction mixture is then kept at 60° C. to 110° C. or in an above-mentioned preferred range for an additional period of time sufficient to complete the reaction, that is, typically from 1.5 to 4 hours, preferably from 2 to 3.5 hours, and most preferably from 2 to 3 hours.

More preferably the cellulose ether is esterified with succinic anhydride or phthalic anhydride in combination with an aliphatic monocarboxylic acid anhydride selected from the group consisting of acetic anhydride, butyric anhydride and propionic anhydride. Most preferably, hydroxypropyl methylcellulose is reacted with succinic anhydride and acetic anhydride to produce hydroxypropyl methyl cellulose acetate succinate.

A delayed addition of succinic acid to the reaction mixture as in step b) of the process of the present invention is disclosed in International Patent Application WO 2014/133885. However, the reaction disclosed in WO 2014/133885 is carried out at a weight ratio of acetic acid to cellulose ether of at least 3:1, but typically of about 3.6:1. This corresponds to a molar ratio of acetic acid to anhydroglucose units of cellulose ether of at least 10:1, but typically of at least 12:1. Most of the reaction examples in WO 2014/133885 are either carried out at 115° C. or over a time period of about 5 hours. Moreover, WO 2014/133885 does not address how to control the weight average molecular weight of HPMCAS. After completion of the esterification reaction, the reaction product can be precipitated from the reaction mixture in a known manner, for example by contacting the reaction mixture with a large volume of water, such as described in U.S. Pat. No. 4,226,981, International Patent Application No. WO 2005/115330 or European Patent Application No. EP 0 219 426. In a preferred embodiment of the invention the reaction product is precipitated from the reaction mixture as described in International Patent Application No. WO 2013/148154 to produce an esterified cellulose ether in the form of a powder.

By the process of the present invention preferably esterified cellulose ethers are produced which comprise groups of the formula —C(O)—R—COOH, wherein R is a divalent aliphatic or aromatic hydrocarbon group, such as —C(O)—CH₂—CH₂—COOH, —C(O)—CH═CH—COOH or —C(O)—C₆H₄—COOH, and monovalent acyl groups, such as acetyl, propionyl, or butyryl, such as n-butyryl or i-butyryl. Specific examples of esterified cellulose ethers are hydroxypropyl methyl cellulose acetate phthalate (HPMCAP), hydroxypropyl methyl cellulose acetate maleate (HPMCAM) or hydroxypropyl methylcellulose acetate succinate (HPMCAS); hydroxypropyl cellulose acetate succinate (HPCAS), hydroxybutyl methyl cellulose propionate succinate (HBMCPrS), hydroxyethyl hydroxypropyl cellulose propionate succinate (HEHPCPrS); or methyl cellulose acetate succinate (MCAS). Hydroxypropyl methylcellulose acetate succinate (HPMCAS) is the most preferred esterified cellulose ether.

The esterified cellulose ethers produced according to the process of the present invention generally have a degree of substitution of aliphatic monovalent acyl groups, such as acetyl, propionyl, or butyryl groups, of at least 0.05, preferably at least 0.10, and more preferably at least 0.25. The esterified cellulose ethers generally have a degree of substitution of aliphatic monovalent acyl groups of up to 1.5, preferably up to 1.0, and more preferably up to 0.6. The esterified cellulose ethers generally have a degree of substitution of groups of formula —C(O)—R—COOH, such as succinoyl, of at least 0.01, preferably at least 0.05, and most preferably at least 0.10. The esterified cellulose ethers generally have a degree of substitution of groups of formula —C(O)—R—COOH of up to 1.3, preferably up to 0.8, and more preferably up to 0.5.

The total degree of ester substitution is generally at least 0.06, preferably at least 0.10, more preferably at least 0.20, and most preferably at least 0.25. The total degree of ester substitution is generally not more than 1.5, preferably not more than 1.2, more preferably not more than 0.90 and most preferably not more than 0.70.

The content of the acetate and succinate ester groups is determined according to “Hypromellose Acetate Succinate, United States Pharmacopia and National Formulary, NF 29, pp. 1548-1550”. Reported values are corrected for volatiles (determined as described in section “loss on drying” in the above HPMCAS monograph). The method may be used in analogue manner to determine the content of propionyl, butyryl, phthalyl and other ester groups. The content of ether groups in the esterified cellulose ether is determined in the same manner as described for “Hypromellose”, United States Pharmacopeia and National Formulary, USP 35, pp 3467-3469. The contents of ether and ester groups obtained by the above analyses are converted to DS and MS values of individual substituents according to the formulas below. The formulas may be used in analogue manner to determine the DS and MS of substituents of other cellulose ether esters.

$$\% cellulose backbone = 100 - ( \% MeO * \frac{M ( {OCH}_{3} ) - M ( OH )}{M ( {OCH}_{3} )} ) - ( \% HPO * \frac{M ( {OCH}_{2} CH ( OH ) {CH}_{3} ) - M ( OH )}{M ( {OCH}_{2} CH ( OH ) {CH}_{3} )} ) - ( \% Acetyl * \frac{M ( {COCH}_{3} ) - M ( H )}{M ( {COCH}_{3} )} ) - \\ ( \% Succinoyl * \frac{M ( {COC}_{2} {H}_{4} COOH ) - M ( H )}{M ( {COC}_{2} {H}_{4} C OOH )} )$$

$$DS ( Me ) = \frac{\frac{\% MeO}{M ( {OCH}_{3} )}}{\frac{\% cellulose backbone}{M ( A G U )}}$$

$$MS ( HP ) = \frac{\frac{\% HPO}{M ( HPO )}}{\frac{\% cellulose backbone}{M ( A G U )}}$$

$$DS ( Acetyl ) = \frac{\frac{\% Acetyl}{M ( Acetyl )}}{\frac{\% cellulose backbone}{M ( A G U )}}$$

$$DS = \frac{\frac{\% Succinoyl}{M ( Succinoyl )}}{\frac{\% cellulose backbone}{M ( A G U )}}$$

$$M ( MeO ) = M ( {OCH}_{3} ) = 31.03 Da$$

$$M ( HPO ) = M ( {OCH}_{2} CH ( OH ) {CH}_{3} ) = 75.09 Da$$

$$M ( Acetyl ) = M ( {COCH}_{3} ) = 43.04 Da$$

$$M ( Succinoyl ) = M ( {COC}_{2} {H}_{4} COOH ) = 101.08 Da$$

$$M ( A G U ) = 162.14 Da$$

$$M ( OH ) = 17.008 Da$$

$$M ( H ) = 1.008 Da$$

By convention, the weight percent is an average weight percentage based on the total weight of the cellulose repeat unit, including all substituents. The content of the methoxyl group is reported based on the mass of the methoxyl group (i.e., —OCH₃). The content of the hydroxyalkoxyl group is reported based on the mass of the hydroxyalkoxyl group (i.e., —O-alkylene-OH); such as hydroxypropoxyl (i.e., —O—CH₂CH(CH₃)—OH). The content of the aliphatic monovalent acyl group is reported based on the mass of —C(O)—R₁ wherein R₁ is a monovalent aliphatic group, such as acetyl (—C(O)—CH₃). The content of the group of formula —C(O)—R—COOH is reported based on the mass of this group, such as the mass of succinoyl groups (i.e., —C(O)—CH₂—CH₂—COOH).

Esterified cellulose ethers are efficiently produced by the process of the present invention which have a weight average molecular weight M_{w} of typically from 20,000 to 150,000 Dalton, more typically from 25,000 to 100,000 Dalton, and most typically from 25,000 to 70,000 Dalton. M_{w} and Mₙ are measured according to Journal of Pharmaceutical and Biomedical Analysis 56 (2011) 743 using a mixture of 40 parts by volume of acetonitrile and 60 parts by volume of aqueous buffer containing 50 mM NaH₂PO₄ and 0.1 M NaNO₃ as mobile phase. The mobile phase is adjusted to a pH of 8.0. The measurement of M_{w} and Mₙ is described in more details in the Examples.

The esterified cellulose ethers produced by the process of the present invention typically have a viscosity of up to 30 mPa·s, preferably up to 25 mPa·s, and in some embodiments of the invention even only up to 20 mPa·s, measured as a 10 wt.-% solution of the esterified cellulose ether in acetone at 20° C. When a higher viscosity of the esterified cellulose ether is acceptable, e.g., of up to 70 mPa·s, measured as a 10 wt.-% solution in acetone at 20° C., a cellulose ether of higher viscosity can be chosen as a starting material, such as a cellulose ether having a viscosity of 4 to 7 mPa·s, measured as a 2 weight-% aqueous solution at 20° C. according to ASTM D2363-79 (Reapproved 2006). The esterified cellulose ethers typically have a viscosity of 10 mPa·s or more, more typically of 15 mPa·s or more, measured as a 10 wt.-% solution of the esterified cellulose ether in acetone at 20° C.

Some embodiments of the invention will now be described in detail in the following Examples.

### EXAMPLES

Unless otherwise mentioned, all parts and percentages are by weight. In the Examples the following test procedures are used.

### Viscosity of Hydroxypropyl Methyl Cellulose Acetate Succinate (HPMCAS)

The 10 wt % solution of the esterified cellulose ether in acetone was prepared by first determining the loss on drying of the HPMCAS according “Hypromellose Acetate Succinate, United States Pharmacopia and National Formulary, NF 29, pp. 1548-1550”. Subsequently 10.00 g HPMCAS, based on its dry weight, was mixed with 90.0 g of acetone under vigorous stirring at room temperature. The mixture was rolled on a roller mixer for about 24 hours. The solution was centrifuged at 2000 rpm for 3 minutes using a Megafuge 1.0 centrifuge, commercially available from Heraeus Holding GmbH, Germany, followed by an Ubbelohde viscosity measurement at 20° C. according to DIN 51562-1:1999-01 (January 1999).

### Content of Ether and Ester Groups of HPMCAS

The content of ether groups in the esterified cellulose ether was determined in the same manner as described for “Hypromellose”, United States Pharmacopeia and National Formulary, USP 35, pp 3467-3469.

The ester substitution with acetyl groups (—CO—CH₃) and the ester substitution with succinoyl groups (—CO—CH₂—CH₂—COOH) were determined according to Hypromellose Acetate Succinate, United States Pharmacopia and National Formulary, NF 29, pp. 1548-1550”. Reported values for ester substitution were corrected for volatiles (determined as described in section “loss on drying” in the above HPMCAS monograph).

Determination of M_{w} and Mₙ of HPMCAS

Mw and Mn were measured according to Journal of Pharmaceutical and Biomedical Analysis 56 (2011) 743 unless stated otherwise. The mobile phase was a mixture of 40 parts by volume of acetonitrile and 60 parts by volume of aqueous buffer containing 50 mM NaH2PO4 and 0.1 M NaNO3. The mobile phase was adjusted to a pH of 8.0. Solutions of the cellulose ether esters were filtered into a HPLC vial through a syringe filter of 0.45 μm pore size.

More specifically, the utilized Chemicals and solvents were: Polyethylene oxide standard materials (abbreviated as PEOX 20 K and PEOX 30 K) were purchased from Agilent Technologies, Inc. Palo Alto, Calif., catalog number PL2083-1005 and PL2083-2005.

Acetonitrile (HPLC grade ≥99.9%, CHROMASOL plus), catalog number 34998, sodium hydroxide (semiconductor grade, 99.99%, trace metal base), catalog number 306576, water (HPLC grade, CHROMASOLV Plus) catalog number 34877 and sodium nitrate (99.995%, trace metal base) catalog number 229938 were purchased from Sigma-Aldrich, Switzerland.

Sodium dihydrogen phosphate (≥99.999% TraceSelect) catalog number 71492 was purchased from FLUKA, Switzerland.

The normalization solution of PEOX20 K at 5 mg/mL, the standard solution of PEOX30 K at 2 mg/mL, and the sample solution of HPMCAS at 2 mg/mL were prepared by adding a weighed amount of polymer into a vial and dissolving it with a measured volume of mobile phase. All solutions were allowed to dissolve at room temperature in the capped vial for 24 h with stirring using a PTFE-coated magnetic stirring bar.

The normalization solution (PEOX 20k, single preparation, N) and the standard solution (PEOX30 K, double preparation, S1 and S2) were filtered into a HPLC vial through a syringe filter of 0.02 μm pore size and 25 mm diameter (Whatman Anatop 25, catalog number 6809-2002), Whatman.

The test sample solution (HPMCAS, prepared in duplicate, T1, T2) and a laboratory standard (HPMCAS, single preparation, LS) were filtered into a HPLC vial through a syringe filter of 0.45 μm pore size (Nylon, e.g. Acrodisc 13 mm VWR catalog number 514-4010).

Chromatographic condition and run sequence were conducted as described by Chen, R. et al.; Journal of Pharmaceutical and Biomedical Analysis 56 (2011) 743-748). The SEC-MALLS instrument set-up included a HP1100 HPLC system from Agilent Technologies, Inc. Palo Alto, CA; a DAWN Heleos II 18 angle laser light scattering detector and a OPTILAB rex refractive index detector, both from Wyatt Technologies, Inc. Santa Barbara, CA. The analytical size exclusion column (TSK-GEL® GMPWXL, 300×7.8 mm) was purchased from Tosoh Bioscience. Both the OPTILAB and the DAWN were operated at 35° C. The analytical SEC column was operated at room temperature (24±5° C.). The mobile phase was a mixture of 40 volume parts of acetonitrile and 60 volume parts of aqueous buffer containing 50 mM NaH2PO4 and 0.1 M NaNO3 prepared as follows:

Aqueous buffer: 7.20 g of sodium dihydrogen phosphate and 10.2 g of sodium nitrate were added to 1.2 L purified water in a clean 2 L glass bottle under stirring until dissolution.

Mobile phase: 800 mL of acetonitrile were added to 1.2 L of the aqueous buffer prepared above, and stirred until a good mixture was achieved and the temperature equilibrated to ambient temperature.

The mobile phase was pH adjusted to 8.0 with 10M NaOH and filtered through a 0.2 m nylon membrane filter. The flow rate was 0.5 mL/min with in-line degassing. The injection volume was 100 μL and the analysis time was 35 min.

The MALLS data were collected and processed by Wyatt ASTRA software (version 5.3.4.20) using dn/dc value (refractive index increment) of 0.120 mL/g for HPMCAS. The light scattering signals of detector Nos. 1-4, 17, and 18) were not used in the molecular weight calculation. A representative chromatographic run sequence is given below: B, N, LS, S1 (5×), S2, T1 (2×), T2 (2×), T3 (2×), T4 (2×), S2, T5(2×), etc., S2, LS, W, where, B represents blank injection of mobile phase, N1 represents normalization solution; LS represents a laboratory standard HPMCAS; S1 and S2 represent standard solutions one and two, respectively; T1, T2, T3, T4, and T5 represent test sample solutions and W represents water injection. (2×) and (5×) denote the number of injections of the same solution.

Both the OPTILAB and the DAWN were calibrated periodically according to the manufacturer's recommended procedures and frequency. A 100 μL injection of a 5 mg/mL polyethylene oxide standard (PEOX20 K) was employed for normalizing all angle light scattering detectors relative to 90. detector for each run sequence.

Use of this mono-dispersed polymer standard also enabled the volume delay between the OPTILAB and the DAWN to be determined, permitting proper alignment of the light scattering signals to the refractive index signal. This is necessary for the calculation of the weight-averaged molecular weight (Mw) for each data slice.

Production of HPMCAS of Example 1

A hydroxypropyl methylcellulose (HPMC), glacial acetic acid and sodium acetate were introduced into a reaction vessel in the amounts listed in Table 1 below. The amount of HPMC was calculated on a dried basis. The HPMC had a methoxyl substitution (DSM) of 1.87, a hydroxypropoxyl substitution (MS_{HP}) of 0.24 and a viscosity of 3.3 mPa·s, measured as a 2% solution in water at 20° C. according to ASTM D2363-79 (Reapproved 2006). The weight average molecular weight of the HPMC was about 20,000 Dalton. The HPMC is commercially available from The Dow Chemical Company as Methocel E3 LV Premium cellulose ether.

The mixture of HPMC, glacial acetic acid and sodium acetate was heated to 85° C. Then acetic anhydride was added to the mixture in the amount listed in Table 1 below. The time of acetic anhydride was designated as “time (t)=zero”.

The mixture of HPMC, glacial acetic acid, sodium acetate and acetic anhydride was allowed to react for 35 minutes at 85° C. while the reaction mixture was stirred. Then succinic acid anhydride was added to the mixture in the amount listed in Table 1 below.

The reaction was allowed to proceed for additional 145 min. The total reaction time at 85° C. was 3 hours, calculated from the addition of acetic anhydride. The product was precipitated with 2.32 L of water that was added to the reaction vessel and the precipitate was collected and subsequently washed with water having a temperature of 21° C. by applying high shear mixing using an Ultra-Turrax stirrer S50-G45 running at 5200 rpm. Washing was conducted in several portions with intermediate filtration steps to obtain HPMCAS of high purity. After the last filtration step the product was dried at 50° C. overnight.

Production of HPMCAS of Comparative Example A

The same mixture of HPMC, glacial acetic acid and sodium acetate as in Example 1 was heated to 85° C. Then succinic anhydride and three minutes later acetic anhydride were added to the mixture in the amounts listed in Table 1 below. The amounts of succinic anhydride and acetic anhydride were chosen to achieve about the same degree of substitution with acetyl groups and about the same degree of substitution with succinoyl groups as in Example 1.

The reaction was allowed to proceed for additional 180 min. The product was precipitated with water, washed and dried as in Example 1.

Production of HPMCAS of Example 2

Example 1 was repeated, except that the amounts of HPMC, acetic acid, sodium acetate, acetic anhydride and succinic anhydride were as listed in Table 1 below.

Production of HPMCAS of Example 3

Example 1 was repeated, except that the amounts of HPMC, acetic acid, sodium acetate, acetic anhydride and succinic anhydride were as listed in Table 1 below.

Production of HPMCAS of Comparative Example B

The same mixture of HPMC, glacial acetic acid and sodium acetate as in Example 2 was heated to 85° C. Then succinic anhydride and three minutes later acetic anhydride were added to the mixture in the amounts listed in Table 1 below. The amounts of succinic anhydride and acetic anhydride were chosen to achieve about the same degree of substitution with acetyl groups and about the same degree of substitution with succinoyl groups as in Example 2.

The reaction was allowed to proceed for additional 180 min. The product was precipitated with water, washed and dried as in Example 1.

Production of HPMCAS of Comparative Example C

Comparative Example B was repeated, except that the amounts of HPMC, acetic acid, sodium acetate, acetic anhydride and succinic anhydride were as listed in Table 1 below.

Production of HPMCAS of Example 4

The same HPMC as in Example 1 and glacial acetic acid were introduced into a reaction vessel in the amounts listed in Table 1 below. 50.1 g of sodium acetate was added, i.e., only 25% wt. % of the entire amount of sodium acetate added to the reaction vessel during the entire reaction. The mixture of HPMC, glacial acetic acid and sodium acetate was heated to 85° C. Then acetic anhydride was added to the mixture in the amount listed in Table 1 below. The time of acetic anhydride was designated as “time (t)=zero”.

The mixture of HPMC, glacial acetic acid, sodium acetate and acetic anhydride was allowed to react for 35 minutes at 85° C. while the reaction mixture was stirred. Then succinic acid anhydride was added to the mixture in the amount listed in Table 1 below. The mixture was stirred for 5 minutes and then 150.2 g of sodium acetate was added, i.e., the remaining 75% wt. % of the entire amount of sodium acetate added to the reaction vessel during the reaction.

The reaction was allowed to proceed for additional 140 min. The total reaction time at 85° C. was 3 hours, calculated from the addition of acetic anhydride. The product was precipitated with water, washed and dried as in Example 1.

Production of HPMCAS of Comparative Example D

The same mixture of HPMC, glacial acetic acid and sodium acetate as in Example 4 was heated to 85° C. Then succinic anhydride and three minutes later acetic anhydride were added to the mixture in the amounts listed in Table 1 below. The amounts of succinic anhydride and acetic anhydride were chosen to achieve about the same degree of substitution with acetyl groups and about the same degree of substitution with succinoyl groups as in Example 4. The mixture was stirred for 30 minutes and then 150.2 g of sodium acetate was added, i.e., the remaining 75% wt. % of the entire amount of sodium acetate added to the reaction vessel during the reaction.

The reaction was allowed to proceed for additional 150 min. The product was precipitated with water, washed and dried as in Example 1.

Production of HPMCAS of Comparative Example E

Comparative Example D was repeated, except that the amounts of HPMC, acetic acid, sodium acetate, acetic anhydride and succinic anhydride were as listed in Table 1 below.

Production of HPMCAS of Example 5

Example 3 was repeated, except that the HPMC had a methoxyl substitution (DSM) of 1.85, a hydroxypropoxyl substitution (MSHP) of 0.26 and a viscosity of 5.3 mPa·s, measured as a 2% solution in water at 20° C. according to ASTM D2363-79 (Reapproved 2006). The HPMC is commercially available from The Dow Chemical Company as Methocel E5 LV Premium cellulose ether. The amounts of HPMC, acetic acid, sodium acetate, acetic anhydride and succinic anhydride were as listed in Table 1 below.

The properties of the HPMCAS of Examples 1-5 and Comparative Examples A-E are listed in Table 2 below. In Table 2 the abbreviations have the following meanings:
DS_{Ac}: degree of substitution with acetyl groups; and
DSₛ: degree of substitution with succinoyl groups.

The results in Table 2 below illustrate that in Examples 1-5, where acetic anhydride and the cellulose ether are reacted at least 15 minutes before succinic acid anhydride is added to the reaction mixture, HPMCAS of low weight average molecular weight and low viscosity in acetone is produced, although the reaction is run at a low molar ratio of acetic acid/HPMC.

Example 5 illustrates that a HPMCAS of low weight average molecular weight and reasonably low viscosity in acetone is obtained, even when HPMC of a viscosity of 5.3 mPa·s is used as a starting material. The use of such HPMC is desirable; less harsh depolymerization conditions are needed than for producing HPMC of lower viscosity. This favorably influences the color of the HPMC and the HPMCAS produced therefrom.

The comparison between Examples 3, 2 and 1 illustrates that in the process of the present invention the molar ratio of aliphatic carboxylic acid, such as acetic acid, to anhydroglucose units of cellulose ether can be reduced without increasing the weight average molecular weight and the viscosity of the produced HPMCAS in acetone.

In contrast thereto, the comparisons between Comparative Examples C and B and between Comparative Examples E and D, respectively, illustrate that the weight average molecular weight and the viscosity of the produced HPMCAS in acetone are substantially increased when the molar ratio of aliphatic carboxylic acid to anhydroglucose units of cellulose ether is reduced. In the Comparative Examples a large molar ratio of aliphatic carboxylic acid to anhydroglucose units of cellulose ether is needed to obtain a HPMCAS of low molecular weight and low viscosity in acetone.

TABLE 1

| | | | | | Succinic | | Acetic | | | | | Acetic | Succinic |
|---|---|---|---|---|---|---|---|---|---|---|---|---|---|
| | | | acetic acid | | anhydride | | anhydride | | Sodium acetate | | Reac- | Anhydride | anhydride |
| (Comp.) | HPMC | | | mol/mol | | mol/mol | | mol/mol | | mol/mol | tion time | addition at | addition at |
| Example | g | mol | g | HPMC | g | HPMC | g | HPMC | g | HPMC | (h) | t = x min | t = x min |
| 1 | 230 | 1.14 | 425 | 6.2 | 41.2 | 0.36 | 110 | 0.99 | 200.3 | 2.15 | 3 | 0 min. | 35 min. |
| A | 230 | 1.14 | 425 | 6.2 | 33.5 | 0.29 | 120 | 1.08 | 200.3 | 2.15 | 3 | 3 min. | 0 min. |
| 2 | 230 | 1.14 | 513 | 7.5 | 46.0 | 0.40 | 125 | 1.12 | 200.3 | 2.15 | 3 | 0 min. | 35 min. |
| 3 | 230 | 1.14 | 590 | 8.65 | 47.0 | 0.41 | 130 | 1.17 | 200.3 | 2.15 | 3 | 0 min. | 35 min. |
| B | 230 | 1.14 | 513 | 7.5 | 37.0 | 0.33 | 166 | 1.49 | 200.3 | 2.15 | 3 | 3 min. | 0 min. |
| C | 230 | 1.14 | 590 | 8.65 | 37.0 | 0.33 | 165 | 1.48 | 200.3 | 2.15 | 3 | 3 min. | 0 min. |
| 4 | 230 | 1.14 | 513 | 7.5 | 43.0 | 0.38 | 175 | 1.57 | 200.3 | 2.15 | 3 | 0 min. | 35 min. |
| D | 230 | 1.14 | 513 | 7.5 | 38.9 | 0.34 | 170 | 1.53 | 200.3 | 2.15 | 3 | 3 min. | 0 min. |
| E | 230 | 1.14 | 750 | 10.99 | 41.0 | 0.36 | 185 | 1.66 | 200.3 | 2.15 | 3 | 3 min. | 0 min. |
| 5 | 230 | 1.14 | 590 | 8.65 | 47.0 | 0.41 | 130 | 1.17 | 200.3 | 2.15 | 3 | 0 min. | 35 min. |

TABLE 2

| | | | 10% | | | | | | |
|---|---|---|---|---|---|---|---|---|---|
| | | | viscosity in | | | | | | |
| (Comparative) | Molecular weight (kDA) | | acetone | Methoxyl | Hydroxy- | Acetyl | Succinoyl | | |
| Example | Mn | Mw | (mPa · s) | (%) | propoxyl (%) | (%) | (%) | DS_{Ac} | DSₛ |
| 1 | 19 | 29 | 18.5 | 23.2 | 7.4 | 8.4 | 12.5 | 0.50 | 0.32 |
| A | 102 | 305 | 101.6 | 23.4 | 7.4 | 8.1 | 12.1 | 0.48 | 0.30 |
| 2 | 18 | 28 | 19.1 | 23.6 | 7.5 | 9.4 | 11.1 | 0.56 | 0.28 |
| 3 | 18 | 27 | 21.0 | 23.6 | 7.4 | 9.3 | 10.6 | 0.55 | 0.27 |
| B | 85 | 238 | 44.3 | 23.4 | 7.2 | 9.8 | 11.4 | 0.59 | 0.29 |
| C | 48 | 129 | 29.5 | 23.6 | 7.4 | 9.3 | 11.2 | 0.55 | 0.28 |
| 4 | 21 | 50 | 17.6 | 23.6 | 7.5 | 10.1 | 10.4 | 0.60 | 0.26 |
| D | 69 | 178 | 33.7 | 23.5 | 7.4 | 9.5 | 11.6 | 0.57 | 0.30 |
| E | 34 | 86 | 19.2 | 23.5 | 7.4 | 8.8 | 11.2 | 0.52 | 0.28 |
| 5 | 26.4 | 46 | 64.7 | 22.9 | 7.4 | 9.7 | 11.7 | 0.58 | 0.30 |

1. A process for reacting a cellulose ether with an aliphatic monocarboxylic acid anhydride and a dicarboxylic acid anhydride in the presence of an aliphatic carboxylic acid, wherein the process comprises the steps of
a) preparing a reaction mixture comprising the cellulose ether, the aliphatic monocarboxylic acid anhydride and the aliphatic carboxylic acid such that the molar ratio of aliphatic carboxylic acid to anhydroglucose units of cellulose ether is up to 9.0:1 and heating the reaction mixture to a temperature of from 60° C. to 110° C. prior to, during or after mixing the components of the reaction mixture, and
b) keeping the reaction mixture at least 15 minutes at the temperature of from 60° C. to 110° C. before adding dicarboxylic acid anhydride to the reaction mixture.

2. A process for producing an esterified cellulose ether having a weight average molecular weight M_{w} of from 20,000 to 150,000 Dalton or a viscosity of up to 30 mPa·s, measured as a 10 wt.-% solution of the esterified cellulose ether in acetone at 20° C., or both in a process for reacting a cellulose ether with an aliphatic monocarboxylic acid anhydride and a dicarboxylic acid anhydride in the presence of an aliphatic carboxylic acid at a molar ratio of aliphatic carboxylic acid to anhydroglucose units of cellulose ether of up to 9.0:1, wherein the process comprises the steps of
a) preparing a reaction mixture comprising the cellulose ether, the aliphatic monocarboxylic acid anhydride and the aliphatic carboxylic acid such that the molar ratio of aliphatic carboxylic acid to anhydroglucose units of cellulose ether is up to 9.0:1 and heating the reaction mixture to a temperature of from 60° C. to 110° C. prior to, during or after mixing the components of the reaction mixture, and
b) keeping the reaction mixture at the temperature of from 60° C. to 110° C. before adding dicarboxylic acid anhydride to the reaction mixture.

3. The process of claim 1 wherein the molar ratio [aliphatic carboxylic acid/anhydroglucose units of cellulose ether] is from [3.4/1] to [8.7/1].

4. The process of claim 1 wherein additionally an esterification catalyst is incorporated into the reaction mixture and a portion or the entire amount of the esterification catalyst is added in step a) to the reaction mixture.

5. The process of claim 1 wherein an esterification catalyst is incorporated into the reaction mixture at a molar ratio [esterification catalyst/anhydroglucose units of cellulose ether] of from [1.0/1] to [3.5/1] and a portion or the entire amount of the esterification catalyst is added in step a) to the reaction mixture.

6. The process of claim 1 wherein the reaction mixture comprising the cellulose ether, the aliphatic monocarboxylic acid anhydride, the esterification catalyst and the aliphatic carboxylic acid is kept at least 20 minutes at a temperature of from 75° C. to 95° C. before dicarboxylic acid anhydride is added to the reaction mixture.

7. The process of tiny claim 1 wherein the cellulose ether is an alkyl cellulose, a hydroxyalkylcellulose or a hydroxyalkyl alkylcellulose.

8. The process of claim 7 wherein the cellulose ether is hydroxypropyl methylcellulose.

9. The process of claim 1 wherein the cellulose ether is esterified. with (i) succinic anhydride or phthalic anhydride and (ii) an aliphatic monocarboxylic acid anhydride selected from the group consisting of acetic anhydride, butyric anhydride and propionic anhydride.

10. The process of claim 9 wherein hydroxypropyl methylcellulose is esterified with succinic anhydride and acetic anhydride to produce hydroxypropyl methyl cellulose acetate succinate.

11. The process of claim 1 wherein the produced esterified cellulose ether has a viscosity of up to 25 mPa·s, measured as a 10 wt. % solution of the esterified cellulose ether in acetone at 20° C.

12. The process of claim 1 wherein the produced esterified cellulose ether has a weight average molecular weight M_{w} of from 25,000 to 100,000 Dalton.

13. The process of claim 1 wherein the molar ratio between the anhydride of the aliphatic monocarboxylic acid and the anhydroglucose units of the cellulose ether is from 0.3/1 to 4.0/1 and/or the molar ratio between the anhydride of a dicarboxylic acid and the anhydroglucose units of cellulose ether is from 0.04/1 to 1.0/1.

14. The process of claim 1 wherein the cellulose ether has a viscosity of from 2.4 to 10 mPa·s, measured as a 2 weight-% solution in water at 20° C. according to ASTM D2363-79, reapproved 2006.

15. The process of claim 1 wherein after addition of the last amount of dicarboxylic acid anhydride the reaction is allowed to proceed at a temperature of 60° C. to 110° C. for 2 to 3 hours.
